(19) United States
(12) Patent Application Publication
(10) Pub. No.: US 2016/0001229 A1
(43) Pub. Date: Jan. 7, 2016

(54) PARTICULATE MATTER FILTER WITH CATALYTIC ELEMENTS

(71) Applicant: CUMMINS IP, INC., Minneapolis, MN (US)

(72) Inventors: Richard J. Ancimer, Toronto (CA); Arvind V. Harinath, Columbus, IN (US)

(73) Assignee: Cummins IP, Inc., Minneapolis, MN (US)

(21) Appl. No.: 14/768,109

(22) PCT Filed: Feb. 28, 2014
(86) PCT No.: PCT/US2014/019343

§ 371 Date: Aug. 14, 2015

Related U.S. Application Data
(60) Provisional application No. 61/774,438, filed on Mar. 7, 2013.

(51) Int. Cl. B01D 53/94; B01J 37/02

(52) U.S. Cl. CPC B01D 53/9431; B01J 37/0228; B01D 53/9477; B01D 2255/904

(57) ABSTRACT

Described herein is a selective catalytic reduction (SCR) filter that includes a substrate that includes a first surface on a first side of the substrate and second surface on a second side of the substrate. The SCR filter further includes a semi-permeable membrane applied to the first surface. Additionally, the SCR filter includes an SCR washcoat applied to the second surface.

### CROSS-REFERENCE TO RELATED APPLICATION

The present application claims priority to U.S. Provisional Patent Application No. 61/774,438, filed Mar. 7, 2013 and entitled “PARTICULATE MATTER FILTER WITH CATALYTIC ELEMENTS,” which application is incorporated herein by reference in its entirety.

### TECHNICAL FIELD

The present disclosure is related generally to exhaust aftertreatment systems for internal combustion engines, and more specifically to particulate matter filters of exhaust aftertreatment systems.

### BACKGROUND

Emissions regulations for internal combustion engines have become more stringent over recent years. Environmental concerns have motivated the implementation of stricter emission requirements for internal combustion engines throughout much of the world. Governmental agencies, such as the Environmental Protection Agency (EPA) in the United States, carefully monitor the emission quality of engines and set acceptable emission standards, to which all engines must comply. Generally, emission requirements vary according to engine type. Emission tests for compression-ignition (diesel) engines typically monitor the release of diesel particulate matter (PM), nitrogen oxides (NOx), and unburned hydrocarbons (UHC).

Exhaust aftertreatment systems receive and treat exhaust gas generated by an internal combustion engine. Exhaust aftertreatment systems may include various components configured to reduce the level of regulated exhaust emissions present in the exhaust gas. For example, some exhaust aftertreatment systems for diesel powered internal combustion engines include various components, such as a diesel oxidation catalyst (DOC), a particulate matter filter or a diesel particulate filter (DPF), and a selective catalytic reduction (SCR) catalyst. In some exhaust aftertreatment systems, exhaust gas first passes through the diesel oxidation catalyst, then passes through the diesel particulate filter, and subsequently passes through the SCR catalyst.

A wall-flow DPF may include parallel passageways having a substrate, such as a porous ceramic matrix, through which exhaust gas passes before exiting the DPF. The passageways may alternate between open-inlet and closed-outlet passageways and closed-inlet and open-outlet passageways, and the passageways may be separated by the porous ceramic matrix. Such an arrangement forces exhaust gas in the open-inlet and closed-outlet passageways to pass through the porous ceramic matrix and into the closed-inlet and open-outlet passageways. Accordingly, exhaust gas enters the DPF through the open-inlet of some passageways and exits the DPF through the open-outlets of the other passageways. As the exhaust gas passes through the porous ceramic matrix, particulate matter in the exhaust gas accumulates on a surface of the substrate, creating a buildup, which must eventually be removed to prevent obstruction of the exhaust gas flow. Common forms of particulate matter are ash and soot. Ash, typically a residue of burnt engine oil, is substantially incombustible and builds slowly within the filter. Soot, chiefly composed of carbon, results from incomplete combustion of fuel and generally comprises a large percentage of particulate matter buildup. Various conditions, including, but not limited to, engine operating conditions, mileage, driving style, terrain, etc., affect the rate at which particulate matter accumulates within a DPF.

Accumulation of particulate matter typically causes an increase in backpressure within the exhaust system. Excessive backpressure on the engine can degrade engine performance. Particulate matter, in general, oxidizes in the presence of nitrogen dioxide NO₂ at modest temperatures, or in the presence of oxygen at higher temperatures. If too much particulate matter has accumulated when oxidation begins, the oxidation rate may get high enough to cause an uncontrolled temperature excursion. The resulting heat can destroy the filter and damage surrounding structures, components or subcomponents. Repair or replacing the filter and/or surrounding structures, components, or subcomponents can be an expensive process.

To prevent potentially damaging reactions in a particulate filter, accumulated particulate matter is commonly oxidized and removed in a passive regeneration process (e.g., noxidation using NO₂ as the oxidizer) or an active or controlled regeneration process before excessive levels have accumulated. Generally, artificially increasing the exhaust temperature is not necessary to passively regenerate the DPF. However, passive regeneration oxidizes particulate matter on the DPF at a lower rate than active or controlled regeneration. To oxidize greater amounts of particulate matter at higher rates using controlled regeneration, filter temperatures generally must exceed the temperatures typically reached at the filter inlet. Consequently, additional methods to initiate regeneration of a diesel particulate filter may be used. In one method, a reactant, such as diesel fuel, is introduced into an exhaust after-treatment system to increase the temperature of the particulate filter, via exothermic oxidation of the reactant over a catalyst causing the increase in the filter temperature, and thereby initiate oxidation of particulate buildup. During a filter regeneration event substantial amounts of soot on the particulate filter are oxidized.

A controlled regeneration can be initiated by an engine control system when a predetermined amount of particulate has accumulated on the filter, when a predetermined time of engine operation has passed, and/or when the vehicle has driven a predetermined number of miles. Active oxidation from oxygen (O₂) generally occurs on the filter at temperatures above about 400° C., while passive oxidation from NO₂, sometimes referred to herein as noxidation, generally occurs at temperatures between about 250° C. and 400° C. Active regeneration typically consists of driving the filter temperature up to O₂ oxidation temperature levels for a predetermined time period such that substantial oxidation of the soot accumulated on the filter takes place. The temperature of the particulate filter is dependent upon the temperature of the exhaust gas entering the particulate filter. Accordingly, the temperature of the exhaust should be carefully managed to ensure that a desired particulate filter inlet exhaust filter is accurately and efficiently reached and maintained for a desired duration to achieve a controlled regeneration event that produces desired results.

Although active regeneration oxidizes larger amounts of particulate matter on a DPF compared to passive regeneration, reducing the number of active regeneration events may be desirable to reduce the negative effects of active regeneration events on an internal combustion engine system. For example, active regeneration results in a drop in fuel efficiency due to the modification of engine operations implemented to increase the exhaust gas temperature above the relatively high thresholds required for active regeneration and/or for the injected hydrocarbons to burn over the DOC. Additionally, the extreme temperatures and temperature fluctuations experienced by exhaust aftertreatment components during active regeneration cycles may lead to degradation of the performance of the components and a drop in the useful life of the components. Accordingly, in view of the negative consequences of frequent active regeneration events, some systems do not trigger an active regeneration event until a sufficiently high amount of particulate matter has accumulated on the DPF. Unfortunately, the higher amounts of particulate matter may increase the backpressure on the engine, which results in a reduction in fuel efficiency, as well as other negative consequences. Accordingly, passive oxidation of particulate matter using NO₂ may be selected over active regeneration to incrementally and less invasively reduce some amount of particulate matter on the DPF to promote less frequent active regeneration events and lower exhaust backpressures on the engine.

The SCR catalyst in an exhaust aftertreatment system reduces the amount of nitrogen oxides (NOx) present in the exhaust gas. Generally, the SCR catalyst is configured to reduce NOx into constituents, such as N₂ and H₂O, in the presence of ammonia (NH₃) and NO₂. Because ammonia is not a natural byproduct of lean of stoichiometric combustion processes, it must be artificially introduced into the exhaust gas prior to the exhaust gas entering the SCR catalyst. Typically, ammonia is not directly injected into the exhaust gas due to safety considerations associated with the storage of gaseous ammonia. Accordingly, dosing systems may be designed to inject a reductant (e.g., diesel exhaust fluid (DEF), aqueous urea, etc.) into the exhaust gas, which is capable of decomposing into gaseous ammonia in the presence of exhaust gas under certain conditions. One commonly used reductant includes DEF, which is a urea-water solution.

Generally, the decomposition of reductant into gaseous ammonia occupies three stages. First, the reductant mixes with exhaust gas and water is removed from the reductant through a vaporization process. Second, the temperature of the exhaust causes a thermolysis-induced phase change in the reductant and decomposition of the reductant into isocyanic acid (HNCO) and NH₃. Third, the isocyanic acid reacts with water in a hydrolysis process to decompose into ammonia and carbon dioxide (CO₂). The gaseous ammonia is then introduced at the inlet face of the SCR catalyst, flows through the catalyst, and is consumed in the NOx reduction process. An ammonia oxidation catalyst downstream of the SCR catalyst can be designed to preferentially oxidize any unconsumed ammonia exiting the SCR system can to N₂ and other benign components.

SCR systems typically include a reductant source and a reductant injector or doser coupled to the source and positioned upstream of the SCR catalyst. The reductant injector injects reductant into a decomposition space or tube through which an exhaust gas stream flows. Upon injection into the exhaust gas stream, the injected reductant spray is heated by the exhaust gas stream to trigger the decomposition of reductant into ammonia. As the reductant and exhaust gas mixture flows through the decomposition tube, the reductant further mixes with the exhaust gas before entering an the SCR catalyst. Generally, the reductant delivery system is designed such that the reductant is sufficiently decomposed and mixed with the exhaust gas prior to entering the SCR catalyst to provide an adequately uniform distribution of ammonia at the inlet face of the SCR catalyst.

Some exhaust aftertreatment systems integrate the functionality of particulate matter filtration and NOx reduction into a single unit, which may be referred to as a SCR-on-DPF or selective catalytic reduction filter (SCRF). A SCRF unit may include an SCR washcoat applied onto a porous ceramic matrix of a DPF. A reductant injector may be positioned upstream of the SCRF unit to inject reductant into the exhaust gas prior to entering the SCRF unit. SCRF units are generally designed to filter particulate matter from exhaust gas as it passes through the porous ceramic matrix and reduce NOx in the exhaust gas as it interacts with the catalytic materials of the SCR washcoat.

### SUMMARY

Various embodiments provide SCRFs and methods of manufacturing and implementing SCRFs. In particular embodiments, a selective catalytic reduction filter is provided that includes a substrate that includes a first surface and second surface. The first surface may be opposite the second surface, in accordance with particular embodiments. The SCR filter further includes a semi-permeable membrane applied to the second surface. Additionally, the SCR filter includes an SCR washcoat applied to the second surface.

In particular embodiments of the SCR filter, the substrate is made from a material have a first porosity, and the semi-permeable membrane is made from a material have a second porosity. The first porosity may be higher than the second porosity, in particular embodiments. The second porosity may be sufficiently low to prevent the penetration of soot particles through the semi-permeable membrane and into the substrate.

According to particular embodiments of the SCR filter, the substrate has a first thickness and the semi-permeable membrane has a second thickness. The first thickness may be greater than the second thickness. The substrate may be made from a ceramic matrix in some implementations. The semi-permeable membrane may be made from a polymer in yet some implementations. According to particular embodiments, the semi-permeable membrane includes catalytic materials that oxidize NO in the presence of oxygen to produce NO₂. The catalyst materials of the semi-permeable membrane may be selected from the group consisting of cerium-zirconia, and cobalt potassium titania. The semi-permeable membrane may include a non-SCR washcoat.

In particular embodiments of the SCR filter, the SCR washcoat includes catalytic materials for reducing NH₃ in the presence of NO₂. The semi-permeable membrane helps prevent the catalytic materials of the SCR washcoat from accessing NO₂ in exhaust gas until the exhaust gas passes through the semi-permeable membrane.

In particular embodiments, the SCR filter further includes a plurality of walls that define a plurality of passageways. Each wall includes the substrate, the SCR washcoat, and the semi-permeable membrane, in accordance with particular embodiments. The plurality of passageways may include a plurality of first passageways and a plurality of second passageways. The first passageways may have open inlets and closed outlets, and the second passageways can have closed inlets and open outlets. Each first passageway may be defined by at least two walls. The semi-permeable membrane of each wall that defines the first passageway may be directly adjacent the first passageway. Further, the SCR washcoat of each wall that defines the first passageway is spaced apart from the semi-permeable membrane of the wall by the substrate of the wall, in accordance with particular embodiments.

According to particular embodiments, an exhaust aftertreatment system in exhaust gas receiving communication with an internal combustion engine includes an oxidation catalyst, a selective catalytic reduction filter (SCRF), and a diesel exhaust fluid (DEF) dosing system. The SCRF includes a substrate that has first and second surfaces on first and second sides of the substrate respectively, a semi-permeable membrane applied to the first surface, and an SCR washcoat applied to the second surface. The semi-permeable membrane physically separates passive oxidation reactions on the semi-permeable membrane from NOx-reduction reactions on the SCR washcoat. The DEF dosing system doses DEF downstream of the oxidation catalyst and upstream of the SCRF. The first and second surfaces may be opposite one another.

In particular embodiments, particulate matter in the exhaust gas accumulates on the semi-permeable membrane as the exhaust gas passes through semi-permeable membrane, substrate, and SCR washcoat. The semi-permeable membrane has a lower porosity than the substrate in particular embodiments. The semi-permeable membrane may be thinner than the substrate in yet some implementations. Exhaust gas passing through the SCRF may pass first through the semi-permeable membrane, then through the substrate, and next through the SCR washcoat.

Other various embodiments provide a method for making an SCRF that includes applying a semi-permeable membrane onto a first surface of a first side of a substrate, which includes a porous ceramic matrix. The method also includes applying an SCR washcoat onto a second surface on a second side of the substrate after applying the SCR washcoat onto the first surface. The second surface may be opposite the first surface.

In particular embodiments, the method also includes arranging the semi-permeable membrane, substrate, and SCR washcoat relative to an exhaust inlet and outlet of the SCRF such that exhaust gas passing through the SCRF passes first through the semi-permeable membrane, second through the substrate, and third through the SCR washcoat.

Particulate matter built up on the porous ceramic matrix of a SCRF unit may be removed via both passive and active oxidation. As mentioned above, both passive oxidation of the filter and NOx reduction on the SCR washcoat require the presence of NO₂ in the exhaust gas. The inventors have appreciated that dual processes of passive oxidation and NOx reduction compete for NO₂ in the exhaust gas in SCRF units. The inventors have also appreciated that the main chemical reaction for noxidation, or passively oxidizing particulate matter in the presence of NO₂, occurs at a slower rate than the main chemical reaction for reducing NOx in the presence of NH₃ and NO₂. Accordingly, SCRF units generally consume the NO₂ in the exhaust gas before the noxidation chemical reaction occurs. Consumption of NO₂ before noxidation in a SCRF limits or precludes passive oxidation of particulate matter on the SCRF component thereby leading to increased reliance on active oxidation events, which as noted herein may result in detrimental damage or failure of the filter and surrounding structures, components, or subsystems. The inventors have appreciated that selective catalytic reduction filters (SCRFs) disclosed herein advantageously permit reduced reliance on active oxidation by promoting dual passive oxidation and NOx reduction.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of the present disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a schematic block diagram of an internal combustion engine system according to one embodiment of the present disclosure.

FIG. 2 is a cross-sectional side view of a selective catalytic reduction filter according to one embodiment of the present disclosure.

FIG. 3 is a schematic flow chart diagram of a method of making and using a selective catalytic reduction filter according to one embodiment of the present disclosure.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive SCRFs and methods of manufacturing and implementing SCRFs. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

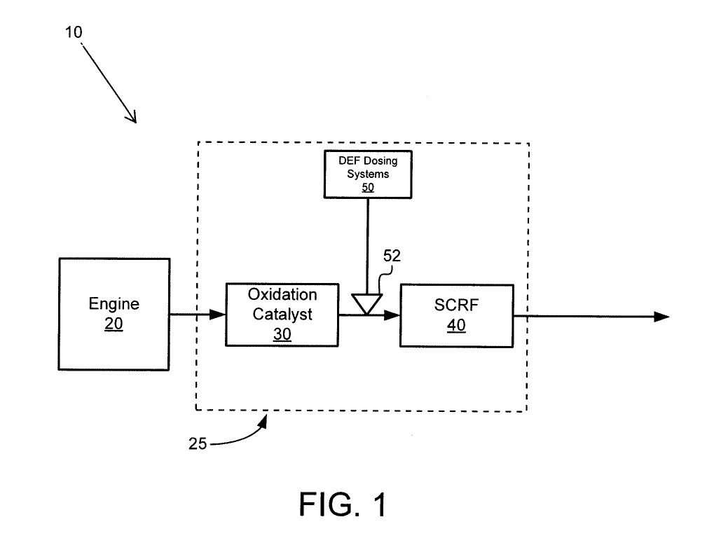

Referring to FIG. 1, one embodiment of an internal combustion engine system 10 includes an internal combustion engine 20 and an exhaust aftertreatment system 25 coupled to the engine. The internal combustion engine 20 can be a compression-ignited internal combustion engine, such as a diesel fueled engine, or a spark-ignited internal combustion engine, such as a gasoline fueled engine operated lean. Within the internal combustion engine 20, air from the atmosphere is combined with fuel to power the engine. Combustion of the fuel and air produces exhaust gas that is operatively vented to an exhaust manifold. From the exhaust manifold, at least a portion of the generated exhaust gas flows into and through the exhaust aftertreatment system 25 via exhaust gas lines as indicated by the directional arrows that are positioned intermediate the various components of the internal combustion engine system 10. Although not shown, the internal combustion engine system 10 may also include a turbocharger operatively coupled to the exhaust gas line between the internal combustion engine 20 and a diesel oxidation catalyst (DOC) 30. Exhaust flowing through the turbocharger may power a turbine of the turbocharger, which drives a compressor of the turbocharger for compressing engine intake air.

Generally, the exhaust aftertreatment system 25 is configured to reduce the number of pollutants contained in the exhaust gas generated by the internal combustion engine 20 before venting the exhaust gas into the atmosphere. An example of one particular embodiment of the exhaust aftertreatment system 25 includes the DOC 30, a selective catalytic reduction filter (SCRF) 40, and a DEF dosing system 50 coupled to a DEF doser 52. In the illustrated embodiment, the DOC 30 is positioned upstream of the DEF doser 52 and upstream of the SCRF 40. The exhaust aftertreatment system 25 can include additional components, such as additional DOCs and SCRFs, or other components not shown, such as ammonia oxidation (AMOX) catalysts, dedicated diesel particulate filter (DPF), and dedicated selective catalytic reduction (SCR) catalyst.

The DOC 30 can be any of various flow-through, diesel oxidation catalysts or other oxidation catalysts known in the art. Generally, the DOC 30 is configured to oxidize at least some particulate matter, e.g., the soluble organic fraction, and NO in the exhaust and reduce unburned hydrocarbons and CO in the exhaust to less environmentally harmful compounds. For example, the DOC 30 may sufficiently reduce the hydrocarbon and CO concentrations in the exhaust to meet the requisite emissions standards. The exhaust aftertreatment system 25 can also include a reactant delivery system (not shown) for introducing a hydrocarbon reactant, such as fuel, into the exhaust gas prior to passing through the DOC 30. Generally, the reactant is oxidized over the DOC 30, which effectively increases the exhaust gas temperature to facilitate active regeneration of the SCRF 40. Alternative, or in addition, to a reactant delivery system, the internal combustion engine system 10 may include a controller that implements a fuel injection timing strategy for injecting fuel into the combustion chambers of the internal combustion engine 20 that results in excess unburned fuel in the exhaust gas exiting the engine. The unburned fuel acts much in the same way as fuel injected externally into the exhaust gas via the reactant delivery system to provide an environment conducive to soot oxidation and regeneration of the particulate filter.

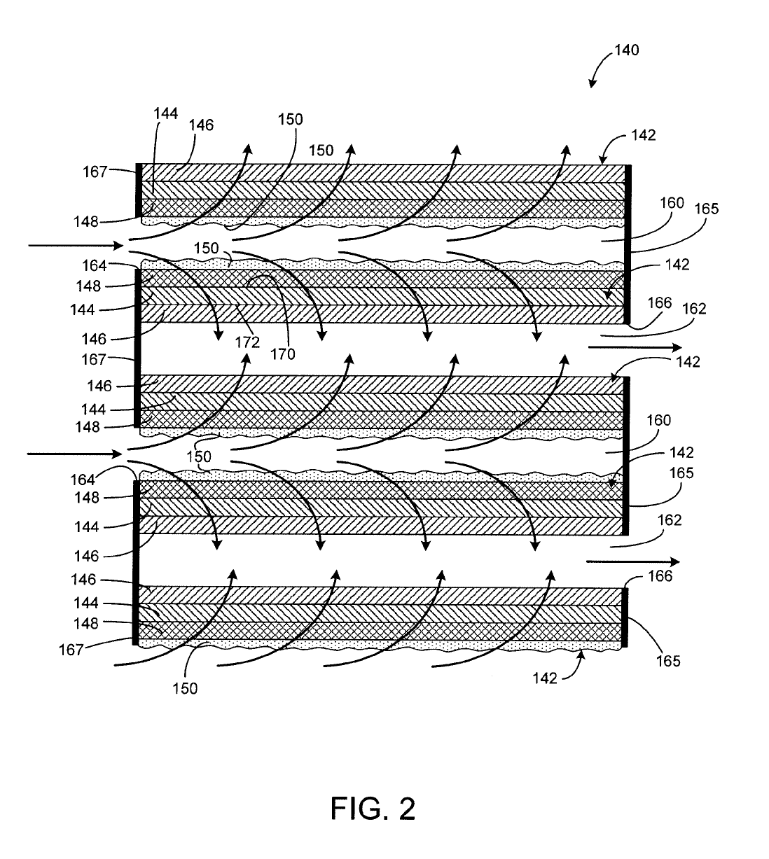

Generally, the SCRF 40 is a DPF with an SCR washcoat applied to the DPF. The SCRF 40 effectively integrates the functionality of particulate matter filtration and NOx reduction into a single component. The SCRF 40 may be the same as or similar to a SCRF 140 shown in cross-section in FIG. 2. The SCRF 140 includes a plurality of exhaust passageways or channels 160, 162 defined between a plurality of walls 142. The walls 142 can have any of various shapes and configurations defining passageways 160, 162 correspondingly having any of various shapes and configurations. Generally, the passageways 160, 162 and the walls 142 are elongate in a lengthwise direction with a thickness or height that is substantially smaller than the length. The width of the walls 142 and passageways 160, 162 can be elongate in a manner similar to their length. For example, in some implementations, the walls 142 are coplanar, extend a width of the SCRF 140, and are spaced apart in a vertical direction to define passageways 160, 162 having a width equal to the width of the SCRF 140 and an elongate rectangular cross-sectional shape along a plane perpendicular to the exhaust flow direction. In other implementations, the width of the walls 142 and passageways 160, 162 is relatively smaller (e.g., similar to the height of the walls and passageways. For example, SCRF 140 may have spaced-apart walls (s) 142 that extend vertically and horizontally and form a grid defining a plurality of passageways 160, 162 with substantially square-shaped cross-sections along a plane perpendicular to the exhaust flow direction. Alternatively, the SCRF 140 may have a honeycomb design with hexagonal-shaped walls 142 defining a plurality of hexagonal-shaped passageways 160, 162 along a plane perpendicular to the exhaust flow direction.

For greater clarity, FIG. 2 is not necessarily shown to scale. In some embodiments, the length of the passageways 160, 162 may be several inches, while the width or height of the passageways 160, 162 may range from less than a millimeter to several millimeters or more. Additionally, for clarity, FIG. 2 only shows several of the plurality of passageways. In other words, an actual SCRF likely has many more passageways than are shown. In one embodiment, the SCRF 140 has an inlet face that is around twelve inches in diameter, with the passageways 160, 162 being about twelve inches long and about 1 millimeter from one wall 142 to an adjacent wall 142.

In the illustrated example embodiment, each wall 142 includes a plurality of layers strategically arranged relative to the passageways 160, 162. The core of each wall 142 includes a substrate 144 or substrate layer. The substrate 144 can be a porous ceramic matrix. The pores of the matrix are sized to allow exhaust gas to flow through, but prevent particulate matter of a certain size from passing through. The particulate matter accumulates onto a first side or surface 170 of the substrate 144 and into the pores of the substrate 144. As described above, the accumulated particulate matter can be removed via passive or active oxidation of the accumulated particulate matter. Passive oxidation requires the presence of NO₂ in exhaust gas, which reacts with the accumulated particulate matter (C) to produce carbon monoxide (CO), which releases the particulate matter from the substrate, and produce nitrogen monoxide (NO) according to the following chemical reaction

C+NO₂→NO+CO (1)

The carbon monoxide resulting from the reaction can further oxidize to convert to carbon dioxide (CO₂). Accordingly, without NO₂, the removal of accumulated particulate matter via passive oxidation or noxidation does not occur.

To facilitate the reduction of NOx in the exhaust gas to less harmful constituents, each wall 142 includes an SCR washcoat 146 or washcoat layer applied onto a second side or surface 172 of the substrate 144. The SCR washcoat 146 can be made from any of various catalytic materials know for reducing NOx in the presence of ammonia, such as zeolites (e.g., Cu-zeolite or Fe-zeolite), or various catalytic elements, such as V, Cr, Mn, Fe, Co, Ni, Cu, Zn, Mo, Ag, Ge, and Nb. In some implementations, carrier materials, such as TiO₂, Al2O₃, SiO₂, ZrO₂, GaO₂, TiO₂—Al₂O₃, TiO₂—SiO₂, TiO₂—GaO₂, TiO₂—ZrO₂, CeO₂, CeO₂—ZrO₂, Al₂O₃—SiO₂, Al₂O₃—ZrO₂, TiO₂—SiO₂—ZrO₂, and TiO₂—Al₂O₃—SiO₂, may be incorporated into the washcoat to help facilitate the catalytic process for reducing NOx in the exhaust gas. The catalytic materials drive one or more chemical reactions for reducing or converting NOx. NOx in the exhaust gas can be reduced at a relatively slow rate without NO₂ according to the following chemical reaction

NO+NH₃+O₂→N₂+H₂O (2)

where NH₃ is ammonia directly or indirectly added to the exhaust stream by the DEF dosing system 50. However, NOx in the exhaust gas can be reduced at a relatively faster rate according to the following chemical reaction

NO+NO₂+2NH₃→2N₂+2H₂O (3)

Because the chemical reaction of Equation 3 occurs faster than the chemical reaction of Equation 2, when NO₂ is present in the exhaust gas stream, NOx is reduced predominately by consuming the NO₂ according to Equation 3. Moreover, typically, the NOx-reducing chemical reaction of Equation 3 also occurs faster than the particulate matter oxidation chemical reaction of Equation 1.

Because the substrate 144 is porous, portions of the SCR washcoat 146 coat the second surface 172 of the substrate, while some portions of the SCR washcoat are adsorbed into the pores of the substrate. To promote passive oxidation on an SCRF, each wall 142 of the SCRF 140 includes a semi-permeable membrane 148 applied to the first surface 170 of the substrate 144. The semi-permeable membrane 148 provides a physical barrier between catalytic materials of the SCR washcoat 146 and particulate matter 150, such as soot, accumulated on the wall. Generally, the semi-permeable membrane 148 is configured to prevent the infusion of catalytic materials from the SCR washcoat 146 into the semi-permeable membrane 148. As discussed herein, embodiments in accordance with the present disclosure provide advantages at least in part through the use of an effective barrier, such as the substrate 144 and/or the semi-permeable membrane 148, disposed between the SCR washcoat 146 and the surface upon which particulate matter accumulates. Due to the separation, provided in particular embodiments via a physical barrier, the catalytic materials of the SCR washcoat 146 cannot access the NO₂ in the exhaust gas until the exhaust gas (with NH₃ and some remaining portion of NO₂) passes through the semi-permeable membrane 148. Accordingly, the separation, provided in the illustrated embodiment by substrate 144, helps accommodate the faster speed of the chemical reaction of Equation 3 with respect to the speed of the chemical reaction of Equation 1 such that an increased amount of NO₂ is left in the exhaust gas for the passive oxidation of particulate matter accumulated on the semi-permeable membrane 148.

In particular embodiments, the semi-permeable membrane 148 is made from a semi-permeable material, such as natural or synthetic polymers or non-polymeric materials, such as metals, ceramics, carbon, and zeolites. In some implementations, the semi-permeable membrane 148 can be a non-SCR washcoat layer applied onto the substrate 144. The semi-permeable membrane 148 can be applied using any of various deposition techniques known in the art, such as plasma, physical vapor, sputtering, and the like.

Generally, the semi-permeable membrane 148 is a relatively thin layer of material with a different porosity (e.g., lower porosity) than the substrate 144. The semi-permeable membrane 148 prevents the particulate matter 150 from penetrating into the substrate 144. The particulate matter 150 accumulates on top of the membrane 148, such that the semi-permeable membrane minimizes interaction with the SCR reaction. Due to the low porosity of the membrane 148, to reduce pressure losses, the semi-permeable membrane 148 may be relatively thin compared to the substrate 144.

In some implementations, the semi-permeable membrane 148 may be a selective membrane that selectively or preferentially oxidizes NO without oxidizing NH₃. As shown above, passive oxidation of particulate matter yields NO and CO. The semi-permeable membrane 148 may include catalytic materials, such as cerium-zirconia (Ce—Zr), cobalt potassium titania, and the like. As NO contacts the semi-permeable membrane 148, and more particularly the catalytic materials of the semi-permeable membrane, the NO is oxidized in the presence of oxygen to produce NO₂. The newly produced NO₂ can be reused to passively oxidize more particulate matter, or pass through the semi-permeable membrane 148 to be used in the NOx-reducing chemical reaction facilitated by the SCR washcoat 146.

The SCRF 140 has a wall-flow configuration to urge exhaust gas through the walls 142 to be filtered by or react with the various layers of the walls. In the illustrated example embodiment, the inlet passageways 160 have an open-inlet and closed-outlet configuration, and the outlet passageways 162 have a closed-inlet and open-outlet configuration. The inlet passageways 160 can be defined herein as inlet passageways because they have an open inlet receiving exhaust gas into the SCRF 140, and the outlet passageways 162 can be defined herein as outlet passageways because they have an open outlet expelling exhaust gas from the SCRF. The inlet passageways 160 each have an open inlet end 164 and a plugged outlet end 165. The plugged outlet end 165 may be a physical plug positioned in the downstream end of the inlet passageways 160 to prevent exhaust gas from flowing out of the downstream end. The outlet passageways 162 each have an open outlet end 166 and a plugged inlet end 167. The plugged inlet end 167 may be a physical plug positioned in the upstream end of the outlet passageways 162 to prevent exhaust gas from flowing into outlet passageway through the downstream end. Other wall flow configuration may be implemented in accordance with embodiments of the present disclosure.

In the illustrated example embodiment, the walls 142 are arranged or oriented such that the semi-permeable membranes 148 of each wall are immediately adjacent the inlet passageways 160, and the SCR washcoats 146 of each wall are immediately adjacent the outlet passageways 162. In other words, the semi-permeable membrane 148 of a wall 142 is positioned between the inlet passageway 160 and the SCR washcoat 146 of the wall.

In operation, with exhaust gas flow being represented by directional arrows in FIG. 2, the SCRF 140 receives reductant-enriched exhaust gas at an inlet of the SCRF. The exhaust gas flows into the inlet passageways 160 via the open inlet ends 164 of the passageways. Due to the plugged outlet ends 165 of the inlet passageways 160, pressure within the inlet passageways 160 increases to a pressure greater than the pressure within the outlet passageways 162. The pressure differential between the inlet passageways 160 and the outlet passageways 162 induces the exhaust gas in the inlet passageways to flow through the semi-permeable walls 142 into the outlet passageways 162 as shown. From the outlet passageways 162, the exhaust gas exits the SCRF 140 through the open outlet ends 166. As the exhaust gas flows through each wall 142, the particulate matter 150 above or equal to a threshold size is trapped on the surface of the semi-permeable membrane 148. Further, as the exhaust gas enriched with ammonia (e.g., decomposed reductant) passes through the substrate 144 and the SCR washcoat 146, NOx in the exhaust gas is reduced. Accordingly, exhaust gas entering the outlet passageways 162 after passing through the walls 142 has reduced quantities of particulate matter and NOx compared to the exhaust gas before passing through the walls.

When exhaust conditions (e.g., exhaust temperature and NO₂ concentrations) are conducive to passive oxidation, the particulate matter 150 accumulated on the semi-permeable membranes 148 is oxidized and removed before NO₂ in the exhaust gas is consumed in the NOx reduction process on the SCR washcoat 146.

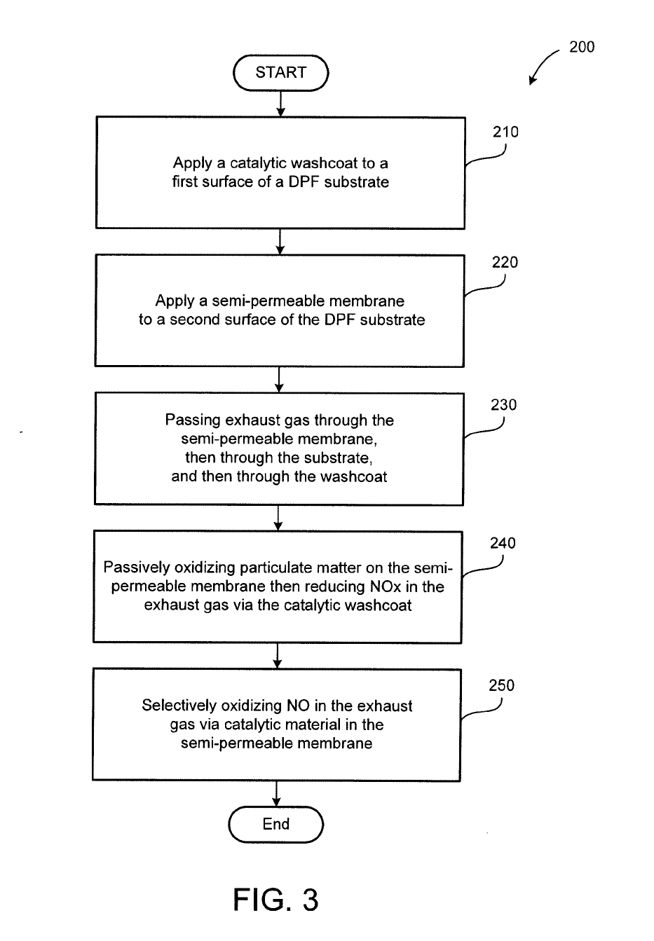

The SCRF 140 can be made using any of various techniques. According to one example embodiment, the SCRF 140 is made according to a method 200 depicted in FIG. 3. The method 200 includes applying a catalytic or SCR washcoat onto a first surface of a DPF substrate at 210. Similarly, the method 200 includes applying a semi-permeable membrane onto a second surface of the DPF substrate at 220. The first surface is opposite the second surface, such that the substrate is positioned between the applied SCR washcoat and semi-permeable membrane. According to one implementation, the SCR washcoat is applied at 210 before the semi-permeable membrane is applied at 220 to avoid the SCR washcoat from contaminating the semi-permeable membrane.

The method 200 further includes passing exhaust gas through the semi-permeable membrane before passing the exhaust gas through the substrate and SCR washcoat at 230. The physical barrier provided by the semi-permeable membrane facilitates the passive oxidization of particulate matter accumulated on the semi-permeable membrane before reducing NOx in exhaust gas on the SCR washcoat at 240. Additionally, the method 200 includes selectively oxidizing NO in the exhaust gas by introducing catalytic materials in the semi-permeable membrane at 250. Selectively oxidizing NO at 250 includes avoiding the oxidization of NH₃ in the exhaust gas. Accordingly, the method may include introducing catalytic materials that oxidize NO, but no not oxidize NH₃.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other example embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A selective catalytic reduction (SCR) filter, comprising:
a substrate comprising a first surface on a first side of the substrate and a second surface on a second side of the substrate, the first surface opposite the second surface, the substrate made from a material having a first porosity, the substrate having a first thickness;
a semi-permeable membrane applied to the first surface, the semi-permeable membrane made from a material having a second porosity, the second porosity lower than the first porosity, the semi-permeable membrane having a second thickness small than the first thickness; and
an SCR washcoat applied to the second surface.

2. (canceled)

3. (canceled)

4. The SCR filter of claim 1, wherein the second porosity is sufficiently low to prevent the penetration of soot particles through the semi-permeable membrane and into the substrate.

5. The SCR filter of claim 1, wherein the substrate has a first thickness and the semi-permeable membrane has a second thickness, and wherein the first thickness is greater than the second thickness.

6. The SCR filter of claim 1, wherein the substrate includes a ceramic matrix.

7. The SCR filter of claim 1, wherein the semi-permeable membrane comprises a polymer.

8. The SCR filter of claim 1, wherein the semi-permeable membrane comprises a ceramic.

9. The SCR filter of claim 1, wherein the semi-permeable membrane comprises catalytic materials that oxidize NO in the presence of oxygen to produce NO₂.

10. The SCR filter of claim 9, wherein the catalyst materials are selected from the group consisting of cerium-zirconia, and cobalt potassium titania.

11. The SCR filter of claim 1, wherein the semi-permeable membrane comprises a non-SCR washcoat.

12. The SCR filter of claim 1, wherein the SCR washcoat comprises catalytic materials for reducing NH₃ in the presence of NO₂, and wherein the semi-permeable membrane prevents the catalytic materials of the SCR washcoat from accessing NO₂ in exhaust gas until the exhaust gas passes through the semi-permeable membrane.

13. The SCR filter of claim 1, further comprising a plurality of walls that define a plurality of passageways, wherein each wall comprises the substrate, the SCR washcoat, and the semi-permeable membrane.

14. The SCR filter of claim 13, wherein the plurality of passageways comprises a plurality of first passageways and a plurality of second passageways, and wherein the first passageways have open inlets and closed outlets, and the second passageways have closed inlets and open outlets.

15. The SCR filter of claim 14, wherein each first passageway is defined by at least two walls, wherein the semi-permeable membrane of each wall defining the first passageway is directly adjacent the first passageway, and wherein the SCR washcoat of each wall defining the first passageway is spaced apart from the semi-permeable membrane of the wall by the substrate of the wall.

16. An exhaust aftertreatment system in exhaust gas receiving communication with an internal combustion engine, comprising:
an oxidation catalyst;
a selective catalytic reduction filter (SCRF) comprising:
a substrate having a first surface on a first side of the substrate and a second surface on a second side of the substrate, the first surface opposite the second surface, the substrate made from a material having a first porosity, the substrate having a first thickness,
a semi-permeable membrane applied to the first surface, wherein the substrate physically separates passive oxidation reactions on the semi-permeable membrane from NOx-reduction reactions on the SCR washcoat, the semi-permeable membrane made from a material having a second porosity, the second porosity lower than the first porosity, the semi-permeable membrane having a second thickness smaller than the first thickness,
a selective catalytic reduction (SCR) washcoat applied to the second surface; and
a diesel exhaust fluid (DEF) dosing system dosing DEF downstream of the oxidation catalyst and upstream of the SCRF.

17. (canceled)

18. The exhaust aftertreatment system of claim 16, wherein particulate matter in the exhaust gas accumulates on the semi-permeable membrane as the exhaust gas passes through the semi-permeable membrane, substrate, and SCR washcoat.

19. (canceled)

20. The exhaust aftertreatment system of claim 18, wherein the semi-permeable membrane is thinner than the substrate.

21. The exhaust aftertreatment system of claim 16, wherein exhaust gas passing through the SCRF passes first through the semi-permeable membrane, then through the substrate, and next through the SCR washcoat.

22. A method for making a selective catalytic reduction filter (SCRF), comprising:
applying a semi-permeable membrane onto a first surface on a first side of the substrate the substrate made from a material having a first porosity, the substrate having a first thickness, the semi-permeable membrane made from a material having a second porosity, the second porosity lower than the first porosity, the semi-permeable membrane having a second thickness smaller than the first thickness; and
applying a selective catalytic reduction (SCR) washcoat onto a second surface on a second side of a substrate comprising a porous ceramic matrix after applying the semi-permeable membrane onto the first surface, the second surface being opposite the first surface.

23. (canceled)

24. The method of claim 22, further comprising arranging the semi-permeable membrane, substrate, and SCR washcoat relative to an exhaust inlet and outlet of the SCRF such that exhaust gas passing through the SCRF passes first through the semi-permeable membrane, second through the substrate, and third through the SCR washcoat.
